(19) United States
(12) Patent Application Publication
(10) Pub. No.: US 2009/0046348 A1
(43) Pub. Date: Feb. 19, 2009

(54) Imaging Apparatus for Influencing Impinging Light

(75) Inventors: Hagen Sahm, Dresden (DE); Hans-Jurgen Roscher, Thum-Jahnsbach (DE); Grit Triebel, Dresden (DE); Volker Wittstock, Dresden (DE); Klaus Wolf, Chemnitz (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A.

(21) Appl. No.: 12/192,509

(22) Filed: Aug. 15, 2008

(30) Foreign Application Priority Data
Aug. 16, 2007 (DE) 10 2007 038 872.3

(51) Int. Cl. G02B 26/06; G01B 11/14

(52) U.S. Cl. 359/290; 356/614

(57) ABSTRACT

An imaging apparatus for influencing impinging light comprising an optical element and an actuator for deforming the optical element is proposed. The optical element has a surface facing the impinging light and the actuator (3) has at least one piezoelectric element. In this case, the piezoelectric element is able to be driven by means of a control device. Moreover, the piezoelectric element is fitted to a rear surface and/or to that surface of the optical element which faces the impinging light. The optical element is borne by means of at least one such bearing element that has direction-dependent compliances for in each case at least one degree of freedom of rotation and/or degree of freedom of displacement, such that it is possible to achieve a substantially longitudinal-force-free bending with a substantially fixed overall position of the optical element.

### CROSS REFERENCE TO RELATED APPLICATIONS

This application claims the priority of German Application No. DE 10 2007 038 872.3, filed on Aug. 16, 2007, the entire contents of which is hereby incorporated fully by reference.

### BACKGROUND OF THE INVENTION

The invention relates to an imaging apparatus for influencing impinging or incident light comprising an optical element and an actuator for deforming the optical element, the optical element having a surface facing the impinging light and the actuator having at least one piezoelectric element, the piezoelectric element being able to be driven by means of a control device. Furthermore, the invention also relates to a method for generating an optical imaging by means of the optical element and a system for setting the position of an image plane of an imaging with the aid of an above imaging apparatus.

In particular, the invention relates to an adaptive optical system which is used principally for manipulating light. Systems of this type are intended to alter the phase particularly in the case of spatially partly coherent or coherent light.

### FIELD OF THE INVENTION

Adaptive optical systems are already widely known from the prior art, a specific class of these systems forming adaptive mirrors. Adaptive mirrors of this type have hitherto been used principally in the field of astronomy. In this case, a surface of the adaptive mirror is configured in deformable fashion, such that phases of the reflected light can be influenced.

In this case, the prior art discloses a number of different methods for deforming the mirror surface or constructions of adaptive mirrors. Actuators are principally used for introducing forces into the mirror to be deformed or into the mirror surface. Piezoelectric actuators, magnetostrictive actuators, electromagnetic actuators or else other actuators are used in this case.

EP 0 743 541 A1 discloses a mirror known according to the preamble. This deformable bimorph mirror has a sleeve-type housing with a reflective surface formed on one surface thereof. In this case, at least two piezoceramic plates are applied on the rear surface of the reflective surface, said plates acting as an actuator. The piezoceramic plates have electrodes which are in each case provided between the plates and connected to one another by means of cables, the polarization vectors of the plates being oppositely directed. The housing embodied in one piece is provided in such a way, however, that the region of the reflective surface has a larger thickness than the peripheral region of this surface. Moreover, a sealing compound is inserted in the housing in the region of the piezoceramic plates, said sealing compound having the task of returning the reflective surface to its initial position under the application of voltage. What is disadvantageous about this construction, however, is that an optical surface made so thick can only be deformed with increased application of force. Since the construction of the piezoceramic plates cannot apply very high forces, however, it is not possible to achieve a deformation in the millimetres range. Moreover, as a result of a deformation implemented in this way, the optical surface experiences an extension, whereby the optical surface is influenced very adversely, for example in terms of its imaging property.

WO 2005/124425 A2 describes a similar construction of a deformable mirror. In this case, the mirror layer is concomitantly formed on an electrode that is continuous over the mirror surface. A combination of two piezoceramic plates polarized in opposite directions is fitted to the free surface of the electrode. A voltage is applied to the two piezoceramic plates, one plate expanding and the other contracting. The application is principally concerned with the arrangement of the electrodes and the construction thereof in order to provide a temperature-insensitive deformable mirror. The optical surface is extended in this construction of a deformable mirror, too, which leads to undesirable losses of quality of the imaging light and reduces the lifetime of such a mirror.

Furthermore, segmented adaptive optics are also known from the prior art. However, they do not have very good shape of the mirror surface.

### SUMMARY OF THE INVENTION

Therefore, it is an object of the invention to provide a method and an imaging apparatus for influencing impinging light by means of an optical element which eliminate the disadvantages of the prior art and which can be used in a simple, cost-effective and effective manner in a broad application spectrum with respect to the influencing parameters of the optical element, without the imaging quality of the optical element being adversely affected.

This object is achieved by means of the features of claim 1 with regard to the imaging apparatus, by means of the features of claim 37 with regard to the method, and by means of the features of claim 47 with regard to a system for setting the image position.

According to the invention, this object is achieved with regard to the imaging apparatus by virtue of the fact that the piezoelectric element is fitted or mounted to a rear surface and/or to that surface of the optical element which faces the impinging light, the optical element being borne by means of at least one such bearing element that has direction-dependent flexibility or compliances for in each case at least one degree of freedom of rotation and/or degree of freedom of displacement, such that it is possible to achieve a substantially longitudinal-force-free bending or deformation with a substantially fixed overall position of the optical element. To put it another way, the bearing element unites in each case at least one degree of freedom of rotation and/or degree of freedom of displacement, such that it is possible to achieve a substantially longitudinal-force-free bending of the optical element. Therefore, although the optical element is fixed as a whole, it can flex freely. Distortions and undesirable extensions are thereby eliminated.

The imaging apparatus according to the invention has, for influencing impinging light, an optical element, advantageously a mirror, and an actuator as adjusting device. In this case, the optical element has a preferably reflective optical surface that faces the impinging light and serves for imaging the impinging light or for generating an imaging from the impinging light. The actuator has at least one piezoelectric element that is driven by means of a control device. The actuator therefore brings about through driving a deformation of the optical element and thus an influencing of the impinging light. For deforming the optical element, the actuator acts on a rear surface and/or on the optical surface or front surface of the optical element. The actuator can act for example only on the rear surface, only on the surface or front surface advantageously alongside the optically active region or on both surfaces of the optical element. The forces for deforming the optical element are particularly advantageously introduced outside the optically active region, such that its optical properties are not adversely influenced. The deformation or warping of the optical element is performed or constrained by the expansion or contraction of the piezoelectric element. Particularly when the optical element is clamped in on both sides, it is advantageous if, in the course of the deformation process, at least one end section of the optical element is borne by means of at least one bearing element such that a disadvantageous extension of the optical element is substantially prevented and a substantially longitudinal-force-free bending of the optical element is effected, such that the optical surface still has a high quality. As an alternative to this, the optical element can also be borne just by means of its central region, the two end sections of the optical element then being bearing-free. Both options have the consequence that the longitudinal force effect of the optical element is zero or very small, whereby an undesirable adverse influencing of the optically active surface is avoided.

Initiating the introduction of forces from outside the optical region of the surface, that is to say e.g. from the rear surface of the optical element or from a region on the surface if at all possible outside the optically active region, furthermore has considerable advantages with regard to the imaging quality. This is because in this way, in contrast to known systems, it is possible neither for the vignettings (shadings) nor for discontinuities to occur in the course of the bending line of the optical element.

By virtue of the action at the rear and/or the action from the surface, only forces which are relatively small in comparison with forces of already known adaptive optical elements are necessary for deforming the optical surface or the optical region. The advantage here is that the optical element can thereby be deformed in a large adjustment range (range for example from a plane optical element or concavely curved optical element to a convex optical element), without excessively high forces having to be applied. That is to say that an adjustment range is possible no longer just in the micrometres range, as known from the prior art, but in the millimetres range. In terms of the aperture relatively large and also very small optical elements can be deformed without any loss of optical quality and without having to use a multiplicity of actuators. This means that, wholly independently of the size of the optical element, the latter can be deformed by means of the actuator in accordance with the required stipulations. Besides large adjustment ranges, a high adjustment speed can furthermore also be achieved by means of the imaging apparatus according to the invention.

Through the use of just one actuator that acts on the rear surface and/or the surface of the optical element, the structural size of the entire imaging apparatus can be kept very small. The control outlay on driving the actuator is also small, therefore, since additional elements for transmitting the forces are not necessary.

By virtue of the different setting or adjustment of the flexure of the optical element, the focal length of the optical element changes in a very large range. Therefore, an imaging apparatus of this type is suitable as an adaptive optical system particularly for tracking light and here particularly in holographic projection devices for tracking wavefronts depending on the position of a viewer when observing a preferably three-dimensional reconstructed scene. Besides the signal tracking or wavefront tracking, the imaging apparatus according to the invention can likewise serve for the dynamic correction of wavefront aberrations, for example of a holographic projection device, and for the correction of system-dictated aberrations.

In one advantageous configuration of the invention it may be provided that the bearing element comprises a spring element. As a result of the resilient embodiment of the bearing element or as a result of its elasticity, at least one, advantageously two end sections of the optical element can be drawn along by this during the deformation or bending of the optical element without the bearing element per se being displaced. Consequently, a sliding layer for the movement of the bearing element is not necessary. By virtue of this configuration of the bearing element and the advantageous provision at both sides of the optical element, when forces are introduced onto the optical element, a symmetrical flexure or buckling can correspondingly be produced, with simultaneous entraining or tracking of the two end sections. The flexure or buckling can be influenced here by means of the control device of the actuator. The above statements are applicable in particular to axially symmetrical optical elements.

In a further advantageous configuration of the invention it may be provided that the bearing element has a rigid intermediate member with at least two articulated joints, one of the articulated joints being connected to the end section of the optical element or one of the holding elements. The articulated joints can be embodied as solid articulated joints. In this way, using simple means, a bearing of the optical element can be made possible by means of which at least one end section of the optical element can be drawn along or tracked during the deformation.

As an alternative to this it may be provided that the bearing element has a deformable additional element, which is connected to one of the holding elements for one of the end sections of the optical element. In this way, it is possible to provide a simplified bearing without additional elements, such as solid articulated joints, for example, for the optical element.

In order that an as far as possible symmetrical flexure of the optical element is achieved, it is advantageous if the deformed optical element or the flexure is circular or can have a polygonal shape depending on the requirement. The holding elements, during the flexure of the optical element, can be drawn in the direction of the element centre by means of the bearing elements. In this way, the longitudinal force effect of the optical element is kept small, with the result that an undesirable extension or distortion of the optical surface is avoided and the required optical quality is ensured without restriction.

A further possibility may likewise advantageously consist in the fact that the bearing element comprises an elastic polymer element that at least partly surrounds the end section of the optical element. In this case, the optical element can be connected to one of the holding elements for example by means of an adhesive layer serving as bearing element or spring element.

If the optical element is borne in its central region, then it may be advantageous for the contact between the optical element and the bearing element to be small enough such that it is possible to achieve a longitudinal-force-free bending of the optical element in the central region. For this purpose, the bearing element may advantageously be a bearing element with line contact or a point bearing. This prevents the optical element from being adversely influenced in the bending line during the deformation process.

In a further advantageous configuration of the invention it may be provided that the piezoelectric element of the actuator is at least one piezoceramic film which is fitted to the rear surface of the optical element and which is produced in such a way that an expansion and/or contraction can be carried out by means of the control device. By designing the actuator as a piezoceramic film, it is possible, using simple means, to achieve a high force for deforming the optical element. Moreover, an actuator of this type has a high robustness and high mechanical stability. The small design obtained in this way enables a structural-space-optimized integration into the entire imaging apparatus, with the result that its construction can be embodied in compact fashion yet large deformations of the optical element are nevertheless achieved by means of the actuator.

In order to produce even higher forces, however, it may advantageously be provided that the piezoelectric element has at least two piezoceramic films which can be driven in opposite senses by means of the control device, the piezoceramic films being arranged parallel to one another at the rear surface of the optical element. However, the effect is not intensified proportionally to the number of piezoceramic films stacked one on top of another. Therefore, it is necessary to precisely weigh up the forces obtained in relation to the number of piezoceramic films. Two or three piezoceramic films are advantageously used.

Such an effect can also be obtained if one piezoceramic film is arranged at the rear surface and one piezoceramic film is arranged at the surface of the optical element, the piezoceramic film fitted to the surface having a cutout for the optically active region, with the result that the latter or the impinging light is not adversely influenced.

In order to elucidate the concept of the bearing according to the invention of the optical element in the imaging apparatus according to the invention, firstly reference is made to FIG. 4, which shows a schematic illustration of an imaging apparatus according to the invention.

In this case, FIG. 4 shows an imaging apparatus 1 upon deformation of an optical element 2, the optical element 2 having the curvature 2′ after deformation. An actuator 3 is illustrated only in principle here and can have one of the embodiments described further below and illustrated in FIGS. 1 to 3. Here the optical element 2 is borne by means of two bearing elements 106 embodied as moveable bearings, holding elements for fixing the end sections of the optical element 2 with the two moveable bearings 106 not being illustrated. In this case, the bearing elements 106 are embodied with spring elements having spring constants that are equal in magnitude. The bearing elements 106 can advantageously be prestressed. The holding elements for the end sections of the optical element 2 are in each case coupled to a bearing element 106. During the deformation of the optical element 2 to 2′, therefore, the two end sections of the optical element 2 are drawn along by the elasticity of the bearing elements 106 during the warping, with the result that the longitudinal force effect of the optical element 2 is small, that is to say that only bending occurs. Since it is assumed here that the entire system behaves symmetrically, the distance change Δx is halved and occurs equally on both sides.

FIG. 9 schematically illustrates a second advantageous concept for bearing the optical element 2. Accordingly, the optical element 2 is borne in its central region by means of a bearing element 806, whereby an unconstrained bending deformation of the optical element 2 is achieved here, too, because the lateral regions of the optical element 2 can move freely. The construction of the imaging apparatus 1 can be significantly simplified in this way. As already in the example described above, the bearing element 806 is embodied as a spring element or elastic bearing element or comprises such an element and is in contact with the optical element 2 over a narrowest possible region or sufficiently small region. This can be effected for example by means of a bearing element with line contact or a point bearing. This means that the bearing of the optical element 2 on the bearing element 806 has a specific region which is very small, but should have at least two corner points in order that a bending is possible.

The bearing element 806 is held fixed in the z direction, with the result that no displacement can be effected. However, in the case of this bearing option care should be taken to ensure that the z displacement is not permitted advantageously in an only very small region. By means of an elastic embodiment on both sides (right and left) of the bearing element 806, however, the optical element 2 can be stabilized in this region.

In an advantageous configuration of the invention it may furthermore be provided that the optical surface of the optical element can be curved with a radius of curvature that can be set in an adjustment range of R=(−∞; −250 mm) to R=(+250 mm; +∞) in accordance with a desired influencing of the light. By means of such a large adjustment range, it is possible to achieve curvatures, in particular flexures, of the optical element which are particularly advantageous or necessary in order to obtain focal lengths of the optical element by means of which, in particular in holographic projection devices, it is possible to realize a tracking of the light in accordance with a changed position of a viewer, for example when observing a three-dimensional scene.

It may additionally be advantageous for the application in a holographic projection device for tracking the light or for setting an image plane of an imaging if a frequency in a range of 2 Hz to 20 Hz, preferably 5 Hz, is provided for deforming the optical element in a large adjustment range, and a frequency of up to 150 Hz is provided for deforming the optical element in a fine adjustment range of 5% around the desired value of the radius. For the purposes of the invention, the large adjustment range means the entire adjustment range. The setting of the radius of the optical element or the flexure can advantageously be effected with 5 Hz in the entire adjustment range. By contrast, a fine range setting of the radius or a small change in the radius in order to precisely set the desired value of the radius can be effected with up to approximately 150 Hz. Such changes effected with up to approximately 150 Hz take place in a range of ±5% around the desired value of the radius. Small adjusting distances are required for small adjustments of the radius, whereby the forces which act on the system are smaller than in the case of the large range adjustment in order for example to produce a first buckling or bending. However, the change must be significantly faster (up to approximately 150 Hz), in order to carry out an optical aberration correction in the case of a 50 Hz signal with three colours. That is to say that the force differences are smaller in the case of small adjusting distances. However, the force nevertheless acts with full magnitude and is not linearly dependent on the absolute position.

In order to enable such highly precise regulations and controls, a system for setting the position of an image plane of an imaging in a normal direction with respect to the image plane according to claim 47 is provided, which has a regulator or a control device, by means of which the imaging apparatus described above can be set in response to an outputting of a sensor, in particular of a position detecting sensor. This system can be used not just preferably for holographic projection devices, but also in other areas. It may be advantageous there if a large range adjustment is effected with a frequency of 2 Hz to 20 Hz, in particular 5 Hz.

It is possible within the scope of the invention to carry out the large range adjustment and the fine range adjustment by means of the actuator.

The object of the invention is furthermore achieved by means of a method for influencing light impinging on the optical element, wherein the optical element is part of an imaging apparatus according to any of claims 1 to 36 and the optical element is deformed by means of an actuator through action on the optical surface and/or rear surface, such that a substantially longitudinal-force-free bending is effected with a substantially fixed overall position of the optical element.

In order to generate an optical imaging or in order to influence the light in an optical apparatus, the imaging apparatus is driven with the optical element in such a way that the optical element changes its focal length, whereby the focusing of the light is altered. This is achieved with a particularly high accuracy with the actuator used, in which case the control or regulation can be effected by means of a computer. In this case, this advantage can preferably be utilized in a holographic projection device for tracking the light in accordance with a position of a viewer when observing a two- and/or three-dimensional scene. In this case, the light is tracked in the region of screen-observer when the observer moves towards the screen or away from it.

A direction of curvature of the surface of the optical element can advantageous be set by setting the polarity (sign) of the voltage applied to the actuator. That is to say that a convex or concave bending line can be produced depending on the polarity of the applied voltage.

In an advantageous configuration of the invention it may furthermore be provided that wavefront aberrations of a wavefront imaged by means of at least one deflection element, the wavefront impinging on the deflection element at an angle, are corrected by means of the imaging apparatus provided with the optical element. If a wavefront emerging from a light source is sent through an optical system, then said wavefront is deformed. The deformed wavefront has the effect that the imaging is disturbed and thus deteriorates. In order to eliminate the wavefront aberrations, the imaging apparatus is driven or regulated and influenced by means of the actuator or the optical element in such a way that the deformation of the wavefront is corrected in real time through a corresponding flexure or curvature of the surface of the optical element.

Furthermore, it may advantageously be provided that the chromatic aberration, in particular the longitudinal chromatic aberration, is corrected by means of the imaging apparatus provided with the optical element. The chromatic aberration occurs if light is diffracted by a lens, for example, the short-wave blue end of the spectrum in this case being diffracted to a greater extent than the long-wave red end. The different light colours are then not focused at the focal point of the lens, since they have different focal points. Since different flexures of the optical element cause different focal lengths, it is thus possible to correct the in particular longitudinal chromatic aberration for an optical system by means of the imaging apparatus. The flexures of the optical element can accordingly be set in such a way that the individual focal points of the light colours are always combined at the reference wavelength focal point of the lens, whereby the chromatic aberration is reduced or eliminated and the image sharpness is thereby increased.

Further configurations of the invention emerge from the rest of the dependent claims. The invention is explained in principle hereinafter on the basis of the exemplary embodiments described in greater detail in the figures.

### BRIEF DESCRIPTION OF THE DRAWINGS

In the figures:

FIG. 1 shows a schematic illustration of a first embodiment of an imaging apparatus for influencing light in side view;

FIG. 2 shows a schematic illustration of a second embodiment of the imaging apparatus in side view;

FIG. 3 shows a schematic illustration of a third embodiment of the imaging apparatus in side view;

FIG. 4 shows a schematic illustration for elucidating the concept of the bearing according to the invention in conjunction with the flexure of the optical element;

FIG. 5 shows a schematic illustration of an excerpt from the bearing illustrated conceptionally in FIG. 4 in accordance with a further embodiment of the invention;

FIG. 6 shows a schematic illustration of an excerpt from the bearing illustrated conceptionally in FIG. 4 in accordance with a further embodiment of the invention;

FIG. 7a shows a schematic illustration of a bearing element in accordance with a further embodiment of the invention;

FIG. 7b shows a schematic illustration of a further bearing element in accordance with a further embodiment of the invention;

FIG. 7c shows a schematic illustration of a fictitious element for illustrating a horizontal tracking of an end section of an optical element;

FIG. 8 shows a schematic illustration of an excerpt from the bearing illustrated in FIG. 4 in a third possibility of the configuration;

FIG. 9 shows a schematic illustration for elucidating a second bearing concept for the optical element;

FIG. 10 shows a schematic illustration of an excerpt from FIG. 9 with regard to a first possibility of the configuration of a bearing element;

FIG. 11 shows a schematic illustration of an excerpt from FIG. 9 with regard to a second possibility of the configuration of a bearing element;

FIG. 12a shows a schematic illustration of an excerpt from a holographic projection apparatus with an imaging apparatus according to the invention with an uncurved surface of the optical element; and

FIG. 12b shows a schematic illustration of the holographic projection device shown in FIG. 12a with a curved surface of the optical element.

### DETAILED DESCRIPTION OF THE INVENTION

The construction and the functioning of an imaging apparatus 1 are described below.

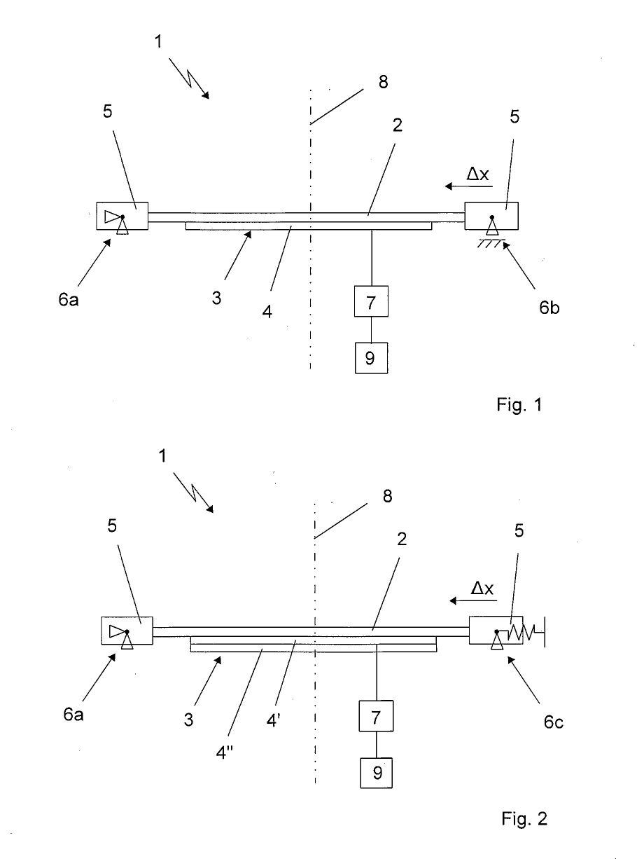

FIG. 1 illustrates the basic construction of an imaging apparatus 1, the imaging apparatus 1 being shown in a highly simplified fashion in side view. The imaging apparatus 1 has alongside an optical element 2, here a mirror, for example, an actuator 3 for deforming the optical element 2. The imaging apparatus 1 is constructed symmetrically in the example shown.

The optical element 2 has a reflective surface or front surface for deflecting or influencing light. For this purpose, the optical element 2 is embodied in deformable fashion. The optical element 2 is preferably a mirror, in particular a cylindrical mirror, that is to say that after introduction of the forces into the optical element 2 by means of the actuator 3 for deformation, the optical element 2 has a reflective optical surface that is not spherical but rather cylindrical. Since the optical element 2 is intended to be configured in deformable fashion, it is important for it to ensure a high optical surface quality in conjunction with a very good elastic deformability and fatigue strength. In order to make this possible, any suitable elastic material can be used as basic material or carrier material, the carrier material preferably being embodied as a thin film, preferably made of plastic. However, the film can also be produced from a metallic material, such as steel (spring steel), for example. In order to produce such an optical element 2 in conjunction with the actuator 3, various possibilities are described briefly below.

A first possibility consists in machining, in a first step, the carrier material, for example finely ground spring steel or plastic, according to predefined parameters, such as size, thickness, shape, etc., using already known machining devices to form a film. Afterwards, in a second step, a material serving as an optical layer is deposited on the film produced. By way of example, 100 μm of nickel (NiP) can be deposited as an optical layer onto the carrier material embodied as a film in the external-current-free method. In this case, the deposition is advantageously effected without striations, inclusions or other faults that influence the optical quality. This nickel-phosphorus coating (NiP) has properties which on the one hand are determined by the phosphorus content and on the other hand can be influenced in a targeted manner with regard to hardness by heat treatment. Moreover, these NiP coatings have a high wear resistance and good corrosion protection, as a result of which a long lifetime of the optical element 2 can be achieved. By using the external-current-free method (chemical deposition) it can be ensured that the coating onto the carrier material is effected in contour-following fashion and always with the same layer thickness. After the NiP coating has been applied, in a further step, the material thus serving as an optical layer is machined by means of a milling method, in particular by means of a rotating, preferably monolithic, diamond tool. The machining of the NiP coating to form the optical surface on the carrier material is thus effected by means of milling, in particular by means of fine machining using a rotating diamond tip (flycutting). In this way, the surface is produced in reflective fashion by UHP machining (Ultra-High-Precision machining).

It is also possible to provide the elastic carrier material, for example CFP (Carbon Fibre Reinforced Plastic), with a smooth surface in such a way that this surface is mirror-coated in order to obtain the optically reflective layer.

In a subsequent step, the film serving as optical element 2 is connected to the actuator 3. This can be effected for example by laminating the film onto the actuator 3, by coating the film with the actuator 3 or else by applying the actuator 3 to the film by means of a thick-film technique.

In FIG. 1 the actuator 3 has a piezoelectric element 4, which is driven by means of a control device 7. The piezoelectric element 4 is advantageously embodied as a uniaxially piezoceramic film and fitted areally on a rear surface of the optical element 2, such that it acts on the rear surface of the optical element 2 and transmits deformation forces to the latter. In this case, the piezoelectric element 4 is configured in such a way that it extends over a majority of the width of the optical element 2. It is particularly advantageous if the piezoelectric element 4 extends over the entire width of the optical element 2, in order thus to be able to correspondingly deform the entire optical element 2 rather than just a part of the latter. It is also possible to fit the piezoelectric element 4 on the surface or front surface of the optical element 2 in the optically non-active region.

In order to deform the optical element 2, which for stable bearing is advantageously influenced such that it becomes polygonal, after production for the influencing of the impinging light by means of the imaging apparatus 1, said element is arranged or mounted in a respective holding element 5 on both sides. A respective holding element 5 connects a bearing element 6a or 6b to the respective end section or edge section of the optical element 2. However, this bearing of the optical element 2 is intended to bring about an elastic bending rather than to produce an elastic extension of the optical element 2. In order to realize this, the right-hand bearing element 6b illustrated in FIG. 1 is embodied as a type of moveable bearing in order to have the effect, upon deformation or curvature of the optical element 2, that the holding element 5 is drawn along with the respective end section in the direction of the centre of the optical element 2. In this case, the left-hand bearing element 6a is a fixed bearing, with the result that the entire device is not displaced in an undesirable manner.

As already mentioned above, the imaging apparatus 1 has an actuator 3 with a piezoelectric element 4 by means of which the deformation of the optical element 2 is performed. The actuator 3, which is embodied as a bending actuator, has a short response time and applies a high achievable force.

In order to realize a deformation or bending of the optical element 2, the actuator 3 is driven by means of a control device 7, whereby a desired direction of flexure or direction of curvature, either concave or convex, can be set by choosing the polarity of the applied voltage. However, the operator of the control device 7 himself can predetermine a defined sign regulation for the applied voltage. This means that depending on how the light is to be influenced, a corresponding voltage, for example of U=−500 V to +1500 V, is applied to the actuator 3 or the piezoelectric element 4 in order to obtain a concave or convex flexure of the optical element 2. For a symmetrical flexure of the optical element 2 it is necessary, of course, to provide a symmetrical voltage of, for example, U=−500 V to +500 V. Moreover, the piezoelectric element 4 is prestressed, such that it can be driven with a negative voltage. After the direction of the flexure has been predetermined by means of the polarity of the voltage, the actuator 3 is driven directly by means of the control device 7, such that a force parallel to an optical axis 8 of the optical element 2 is applied to the optical element 2. The deformation or bending of the optical element 2 is then effected by the unilateral expansion or contraction of the actuator 3. The optical element 2 is thus concomitantly deformed or constrained into flexure by the expansion or contraction, depending on the sign of the applied voltage. The maximum constrained flexure that can be achieved can be influenced depending on the thickness of the optical element 2. Moreover, there is a proportionality between applied voltage and obtainable flexure. The force is accordingly introduced into the optical element 2 outside the optical surface, as a result of which neither vignetting nor discontinuities occur in the course of the bending line.

The optical element 2 is deformed by the expansion or contraction, but without elastic extension, whereby the thickness of the optical element 2 remains constant in the course of flexure. In this case, the end section of the optical element 2 which is coupled to the moveable bearing 6b is entrained simultaneously with the elastic bending of the optical element 2. In this case, the end section of the optical element 2 which is coupled to the fixed bearing 6a is not drawn along in accordance with the bending. Therefore, a translation in the plane of the optical element 2 is produced only on one side of the optical element 2, where Δx is the distance change. The flexure of the optical element 2 is thus achieved by the actuator 3 bringing about a free bending case, which is obtained by the linear displacement of the edge section of the optical element 2.

The deformation of the optical element 2 is elastic and can be brought about in both directions of flexure. During the deformation of the optical element 2 by means of the imaging apparatus 1, all forces are preferably set in a computer-controlled manner and transmitted mechatronically. In this case, a processor unit 9 or a regulator temporally supervises the intensity of the applied forces. The deformation can be monitored by measuring the distance (Δx) in the plane of the optical element 2 or by means of an applied flexure h. The set properties, such as forces, can be represented by way of Δx, h and R (radius of the optical element 2) on an output device.

The optical element 2 preferably has an aperture of approximately 80 mm, a larger or smaller aperture also being possible, of course. The optical element 2 or the optical surface of the optical element 2, prior to its deformation or prior to a driving of the actuator 3 or the piezoelectric element 4 of the actuator 3, has a surface having a radius of virtually R=∞. In this case, the adjustment range of the flexure of the optical element 2 advantageously lies with the imaging apparatus 1 in a range of R=(−∞; −250 mm) to R=(+250 mm; +∞), it being possible to alter the radius of the optical element 2 in the adjustment range depending on the influencing of the light. Given an aperture of approximately 80 mm, this adjustment range corresponds to a flexure h of ±3.5 mm. Such flexures cannot be obtained by means of the conventional apparatuses.

Furthermore, as a result of the application of the required displacement for the deformation of the optical element 2 with the aid of the actuator 3, high adjustment frequencies can be realized and the required forces can be applied. The optical element 2 can be influenced or adjusted over the entire adjustment range or in a large range adjustment of R=−250 mm to R=+250 mm with a frequency of 2 Hz to 20 Hz. A frequency of 5 Hz is particularly advantageous. It is possible, in addition, to adjust the optical element 2 at up to 150 Hz or higher in small adjustment ranges, i.e. changes in the radius of +5% around the desired value (fine range adjustment).

FIG. 2 illustrates a further possibility of the configuration of the actuator 3 in conjunction with the optical element 2. In this case, the piezoelectric element 4 of the actuator 3 has two piezoceramic films 4′ and 4″, which are advantageously driven in opposite senses by means of the control device 7. As a result of the piezoceramic films 4′ and 4″ being driven in opposite senses, high forces can be obtained and large flexures of the optical element 2 can thus be achieved. However, the two piezoceramic films 4′ and 4″ can, of course, also be driven by means of two different control devices. Driving in the same sense would also be possible, but such high forces as achieved in the case of driving in opposite senses cannot be achieved.

In FIG. 2, the two piezoceramic films 4′ and 4″ of the piezoelectric element 4 are fitted parallel to one another on the rear surface of the optical element 2. Both piezoceramic films 4′ and 4″ have the same size and advantageously extend areally over virtually the entire size or width of the optical element 2. It is also possible, however, for one of the two films 4′ or 4″, advantageously the piezoceramic film 4″, to be made smaller in order thus to obtain geometrical effects for example in addition to the deformation. That is to say that a correction of the shape of the optical element 2 can be obtained for example by a variation of the thickness of the piezoceramic films 4′ and 4″. Different maximum bends and forces can therefore be realized by means of a variable combination of differently oriented piezoceramic films 4′ and 4″.

The bearing of the optical element 2 corresponds to the bearing described and illustrated in FIG. 1, the bearing element 6c comprising a spring element, here a tension spring, which can advantageously be prestressed.

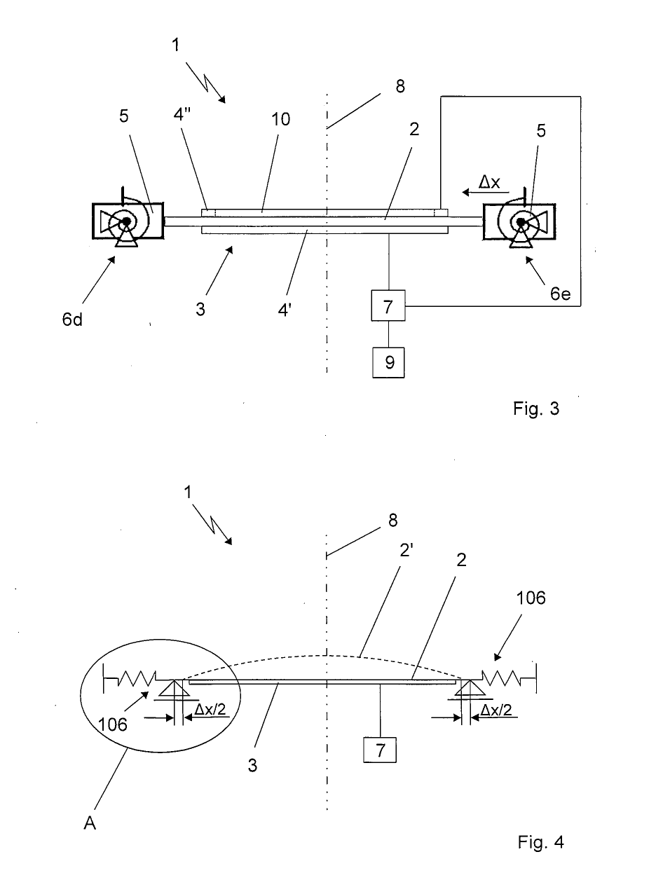

A third possibility of the configuration of the actuator 3 is specified in FIG. 3. Here as well the piezoelectric element 4 has two piezoceramic films 4′ and 4″ that are arranged parallel to one another, one piezoceramic film 4′ being arranged or fitted on the rear surface and one piezoceramic film 4″ being arranged or fitted on the surface of the optical element 2. The piezoceramic film 4″ fitted on the surface has a corresponding cutout 10 for the optically active region serving for the tracking of the optical signal or light. Here, too, as in FIGS. 1 and 2, the optical element 2 is borne by means of a fixed bearing and a moveable bearing, as already described above, the two bearing elements 6d and 6e comprising a spring element, here a torsion spring, which can be prestressed. Here, too, the piezoceramic films 4′ and 4″ of the actuator 3 can be driven in opposite senses or in the same sense in order to obtain a required flexure of the optical element 2.

This possibility is particularly advantageous since, by virtue of this configuration of the actuator 3 and advantageous driving of the piezoceramic films 4′ and 4″ in opposite senses, edge effects that occur during the deformation can be corrected specifically by means of the piezoceramic film 4″.

A further possibility of the configuration of the actuator 3 in conjunction with the optical element 2 is to embody the piezoelectric element 4 as a grating element which can be applied on the surface and/or the rear surface of the optical element 2. This means that, instead of the piezoceramic film 4′ or 4″, piezoceramic webs, for example, are printed directly onto the rear surface and/or surface of the optical element 2 by means of a thick-film technique. In this way, the force acting on the surface and/or on the rear surface of the optical element 2 or the force generated in the piezoceramic webs is nearer to the corresponding surface of the optical element 2 than is the case with piezoceramic films. A higher force effect is thereby achieved.

In order to effect a deformation of the optical element 2 in accordance with FIG. 4 in the case of a symmetrically embodied bearing, first it is necessary to determine or specify the required desired radius depending on the desired influencing of the light, in which case it must be known whether the flexure is intended to have a convex or concave bending line. Depending on which direction of flexure is required, the polarity of the voltage to be applied to the actuator 3 is chosen. The actuator 3 is then driven by means of the control device 7. The actuator 3 thus receives a signal which orders the piezoelectric element 4 to expand and/or contract depending on the required desired radius. In this way, forces are then introduced into the optical element 2, whereby a symmetrical deformation is obtained. Continuous regulation of the forces to be applied is necessary in this case. In order to determine the current radius of the optical element 2, during the flexure process the deformation or the flexure of the optical element 2 can be continuously measured and a desired/actual value adjustment can be performed, a learning measuring unit being used. The current radius can also be determined by way of the measured extension in the optical element 2. It should be taken into consideration that the radius of the optical element 2 is determined indirectly in both of the possibilities mentioned above. For this purpose, the optical element 2 can also be scanned optically. The radius determined at this instant is communicated as a signal for a control device 7 and evaluated. A continuous control or regulation is required in order that the required deformation of the optical element 2 can be performed very precisely. It may be particularly advantageous if, in a first step, a defined radius of the optical element 2 to be deformed is produced in a large adjustment range at 20 Hz, for example, the desired value of the radius then being finely set at 150 Hz, for example, in the case of smaller forces in a second step. Adjustment in a small adjustment range here means a change in the radius in the range of ±5% around the desired value. A change in the radius at 150 Hz is thereby made possible since the forces to be expanded for such a fine range adjustment are small in comparison with the large range adjustment. In this case, it should of course be taken into consideration that the forces acting are subjected to continuous regulation in order to overcome the discontinuity when using the flexure process. In this way, the required desired value of the radius can thus be set with high accuracy.

During the application of the forces it is necessary for the bearing elements 106 to be synchronously entrained or carried along in accordance with the bearing position of the edge sections of the optical element 2. Since the bearing elements 106 which hold the edge sections of the optical element 2 and are connected to the holding elements 5 are embodied as moveable bearings, a linear displacement is achieved and the edge sections are thus drawn along or taken along in accordance with the flexure in the direction of the centre of the optical element 2.

All forces acting on the optical element 2 are set and monitored in a computer-aided manner.

During the deformation of the optical element 2 by means of the imaging apparatus 1, different bending lines, for example a circle, an ellipse, a sine or else a polynomial, can be set by means of a computer-aided synchronized balance of the forces introduced. The bending line is a mathematical description of the deformation of the neutral axis and should be reproducible. That is to say that the bending line must be reproducible depending on the predetermined value. This is advantageously achieved by virtue of the fact that the optical element 2 is borne by means of two symmetrically moved bearing elements 106 which are embodied as moveable bearings and which move towards one another during the deformation of the optical element 2. The reproducibility of the bending line can be influenced and fostered by the choice of different materials for the optical element 2. The bending line behaves differently depending on the material. It is also possible to create learning curves using the formula: R=f(Δx), the predetermined radius or desired radius being compared with the actual value of the radius produced by deformation of the optical element 2, and it is possible to concomitantly take into account possible deviations in the influencing of the light. Procedures of this type make it possible to ensure a high shape fidelity of the bending line. The shape fidelity is intended to remain constant over the entire optical region of the optical element 2.

The bending line can additionally be altered by influencing the cross section of the optical element 2. This means that the cross sections can be influenced prior to mounting the optical element 2 in the holding elements 5 by varying the thickness of the optical element 2. By way of example, the edge regions of the optical element 2 can have a different thickness from the central region, or else vice versa. Consequently, the bending line can be altered by means of the variable thickness of the optical element 2. Moreover, the reproducibility can be improved in this way. The set properties of the bending line to be shaped can likewise be represented by way of Δx, h and R (see FIG. 1) on an output device.

Further different possibilities of an advantageously configuration of bearing elements 106 are described below. The bearing of the optical element 2 can be effected by means of a statically determined bearing or else by means of a statically overdetermined bearing.

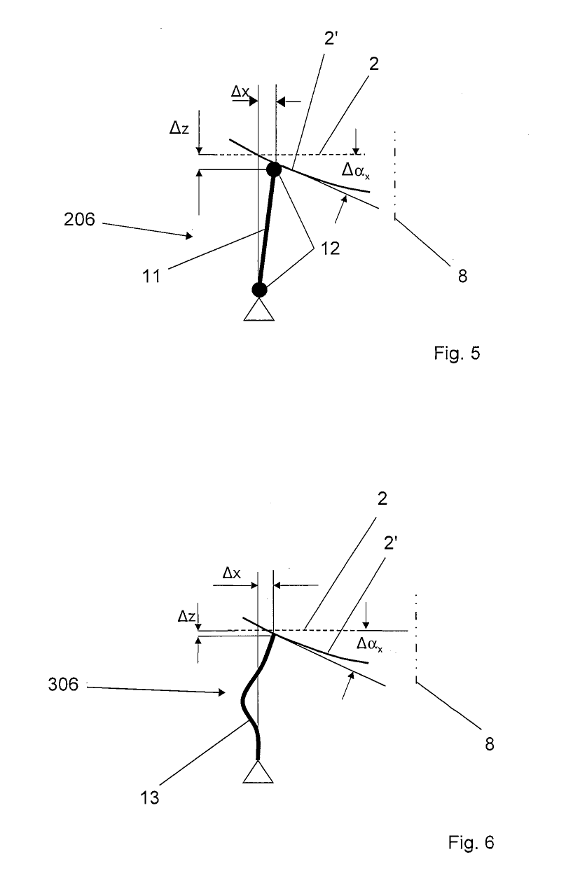

One possibility for the statically determined bearing of the optical element 2 is illustrated in FIG. 5, the excerpt A from FIG. 4 being shown in enlarged fashion. A spring element embodied as bearing element 206 has an intermediate member 11 of rigid characteristic with two solid articulated joints 12, one of the solid articulated joints 12 being connected or coupled to a holding element 5 (not illustrated) for the end section or to the end section of the optical element 2. The other solid articulated joint 12 is fixedly mounted at one location and thus cannot change its position. Both solid articulated joints 12 are free of play. As a result of this configuration, the optical element 2 is thus displaceable in two degrees of freedom, namely in the x direction and in the z direction, and can rotate in one degree of freedom (z direction). In this way, the bearing element or spring element 206 draws along the end section of the optical element 2 in accordance with the flexure Δαₓ.

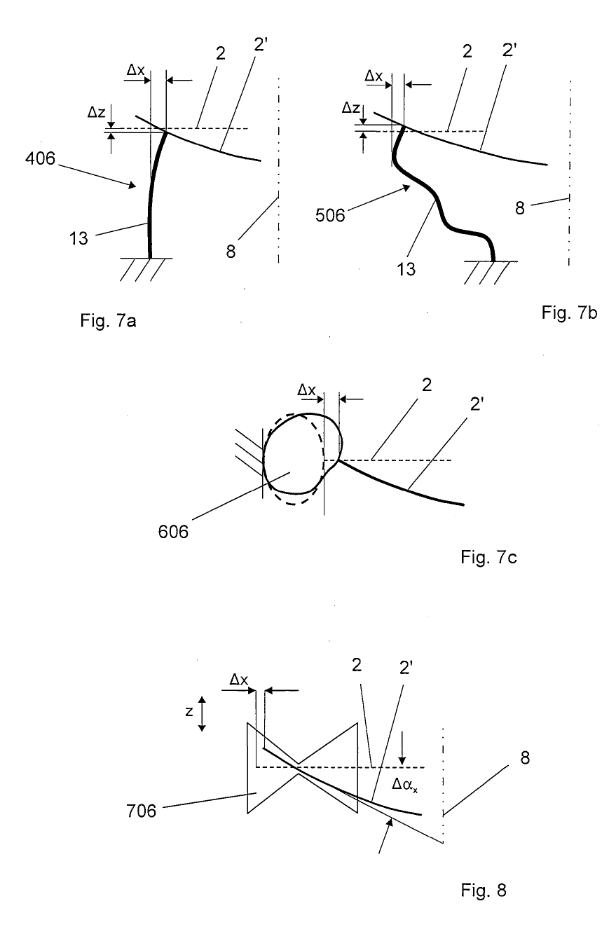

FIG. 6 illustrates a second possibility of the configuration of the bearing element 106 shown in FIG. 4, this bearing likewise being a statically determined bearing. A bearing element 306 is here likewise embodied as a spring element having an additional element 13, which is embodied in deformable fashion, as can be seen on the basis of the bulge, and is connected or coupled to a holding element 5 (not illustrated) for an end section of the optical element 2. Here the additional element 13 is a continuously elastic element, here a rod, and advantageously made of spring steel. In this exemplary embodiment, too, the additional element 13 is fixedly mounted by one end at one location and thus cannot change its position there. As in FIG. 5 likewise two degrees of freedom of displacement (x direction and z direction) and one degree of freedom of rotation (z direction) are realized by means of the additional element 13. Through deformation of the additional element 13, the end section can accordingly be drawn along or entrained during the flexure of the optical element 2. FIGS. 7a, 7b and 7c respectively show a bearing element 406, 506 and 606, the bearing element 606 in FIG. 7c serving only fictitiously for representing the deformation. In this case, the respective bearing element 406, 506 and 606 illustrated in the figures corresponds to the bearing element 306 in FIG. 6. In FIG. 7a, the bearing element 406 or the additional element 13 is provided in the region of the end section of the optical element 2, the additional element 13 being deformed only in the edge region towards the bearing point between additional element 13 and optical element 2. The bearing point is thereby displaced in the x direction and in the z direction, whereby the end section of the flexure of the optical element 2 is drawn along in this way.

FIG. 7b shows a further possibility for the arrangement of a bearing element 506 or of the additional element 13 with respect to the optical element 2. As can be seen, the additional element 13 is no longer fixed at the level of the edge region on a rack or frame, but rather is provided in the central region. This arrangement is possible since the additional element 13 is embodied in elastic fashion. Consequently, it is likewise possible to ensure an entraining of the end section of the optical element 2, whereby the additional element 13 tracks the end section of the optical element 2 by bulging. Such a configuration of the bearing element 506 may be particularly advantageous if, for example, there is no possibility of providing the bearing element 106 in the edge region of the optical element 2.

The one-dimensional stiffness of the additional element 13 arises only upon considering the bearing point between additional element 13 and optical element 2. Within the additional element 13, displacements can occur in all directions (x, y, z direction). In this exemplary embodiment, too, the additional element 13 yields in the x direction and in the z direction during the entrainment. In this way, the elastic rotation of the bearing element 506 is registered as well since a displacement must also be effected with the rotation.

The exemplary embodiments described above all contain a displacement component in the z direction. This displacement can be disregarded, however, in the case of small angular deflections.

FIG. 7c shows a fictitiously embodied bearing element 606, which here as well is embodied as a spring element. The bearing element 606 is once again fixedly fitted at one position on a frame, such that displacement of the entire bearing element 606 is not possible. As can be seen, the bearing element 606 is deformed only in the x direction. A deformation in the z direction does not take place here, however. This means that the bearing point between the bearing element 606 and the optical element 2 always remains on its original line. By means of a bearing element 606 of this type, the bearing point can be displaced in the x direction without a displacement in the z direction simultaneously taking place.

FIG. 8 represents a further possible configuration of the bearing element 106 in accordance with the concept illustrated in FIG. 4. This bearing is a statically overdetermined bearing. This means here that the compensation of the bearing displacement is effected by means of a bearing element 706 itself. For this purpose, the bearing element 706 is embodied discretely elastically. The bearing element 706, which is likewise embodied as a spring element, is produced e.g. from an elastic polymer which at least partly surrounds the end section of the optical element 2 or into which the end section of the optical element 2 is embedded. In this case, the optical element 2 can be connected to the bearing element 706 by means of a virtually rigid clamping. In this way, the optical element 2 cannot move or be displaced in the z direction. A movement of the optical element 2 is therefore possible only in the x direction.

The bearing element 706 or the spring element can also be a viscoelastic bearing element which reacts viscously like a high-viscosity liquid in the event of slow action of forces, but is by contrast elastic in the event of sudden mechanical stress, such as silicone, for example. The bearing element 706 or the elastic polymer element can e.g. also be an adhesive layer in which the optical element 2 is held in the x direction and a fixed connection between adhesive layer and optical element 2 is provided in this way. However, since the entrainment of the end sections of the optical element 2 is only small (in the μm range) in the case of a flexure h=approximately ±−3.5 mm, compensation is nevertheless possible. The bearing element 706 is thus embodied as displaceable in one degree of freedom (x direction) and rotatable in one degree of freedom (z direction).

As an alternative to this, the bearing element 706 can comprise a receptacle surrounding one of the end sections of the optical element 2, an adhesive, elastic composition being accommodated in said receptacle.

With regard to the various bearing elements 206, 306, 406, 506, 606 and 706 in FIGS. 5 to 8, it goes without saying that further degrees of freedom are not excluded. However, they would adversely affect the natural oscillation behaviour of the imaging apparatus 1.

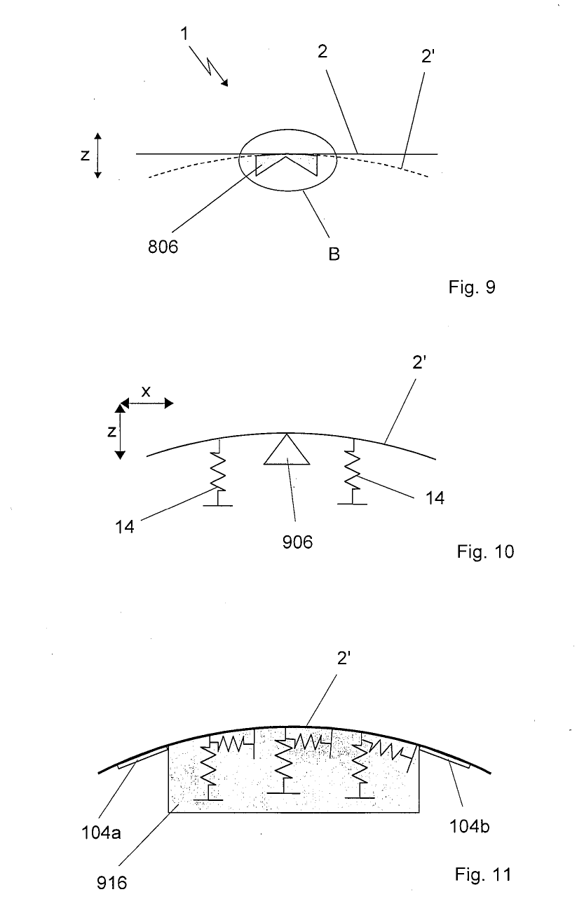

In order to enable the optical element 2 also to be borne in the central region (see FIG. 9), a possibility for the configuration of a bearing element 906 (excerpt B) is illustrated in FIG. 10. The bearing element 906, here a bearing element with line contact or a point bearing, is fixed in the x direction and in the z direction, such that a displacement in these directions is not possible. In addition to the fixed bearing in the centre, in each case laterally with respect thereto, an elastic layer, which here is represented in each case by spring elements 14, is connected to the optical element 2. These layers 14 or spring elements serve for stabilization or prevent the entire bearing from becoming unstable. The elastic layer 14 can be realized by means of a polymer, for example.

The actuator 3 (not illustrated in order to simplify the illustration of the bearing) can be fitted on the surface in the optically non-active region and/or on the rear surface of the optical element 2. On the rear surface, the actuator 3 can be fitted thereto continuously virtually over the entire rear surface, such that the actuator 3 is arranged between the optical element 2 and the bearing element 906 and the layers 14. However, the piezoelectric element 4 of the actuator 3 can also be embodied in a plurality of pieces (see FIG. 11), such that for example a bearing element 916 is connected directly to the optical element 2 and the individual parts or pieces of the piezoelectric element 104a and 104b are fitted laterally with respect thereto on the optical element 2. The deformation of the optical element 2 is then effected by virtue of the fact that the central region virtually remains in its position and the regions running from the central region to the respective end sections are deformed by means of the actuator 3 in order to obtain the required curvature 2′ of the optical element 2. It should be mentioned in this case that only the centre point or the centre line of the optical element 2 experiences no deformation or bending.

FIG. 11 shows a further possibility for the configuration of the bearing shown in FIG. 9. Here the bearing element 916 is made completely of an elastic material, such as a polymer, for example. In order to illustrate the elasticity, spring elements are illustrated in the bearing element 916, said spring elements being configured in such a way that a lateral displacement of the bearing element 916 in the x direction and a displacement in the z direction are not possible. The elastic material can have anisotropic properties. This means that the material is anisotropic with regard to the molecules and the fibre orientation. Strength and stiffness can therefore differ by up to two orders of magnitude depending on the direction. In this configuration of the bearing, too, the bearing element 916 should only take up a small region with respect to the optical element 2. The arrangement of the actuator 3 can be effected as described under FIG. 10, as can the deformation of the optical element 2.

Owing to the bearing of the optical element 2 in its central region, the end sections do not have to be drawn along or tracked, whereby a simpler construction can be obtained.

For configuring the damping in order to avoid large amplitudes in the case of resonance, discrete and continuous damping elements can be provided. This can mean that the bearing elements 306, 406, 506, 606, 706, 806, 906 and 916 are themselves damping elements. With regard to FIG. 8, viscoelastic materials or adhesive layers can be used as damping bearing elements 706. With regard to FIGS. 6, 7a, 7b, 7c, 9, 10 and 11, the damping can be effected in a semiactive manner or in a passive manner. In the case of a semiactive damping, this is effected for example by means of a piezoceramic film which effects damping only in the resonance range. The piezoceramic film can be fitted to the additional element 13, for example, whereby the direct piezoelectric effect is utilized. An additional active damping can be effected by further actuators, in which case the latter, for damping purposes, apply a counter-oscillation with respect to the oscillation generated by the additional element 13. Piezo-based materials can likewise be used for actuators of this type. A passive damping can be obtained by means of a polymer coating (sandwich design). By way of example, the additional element 13 can be coated with a polymer coating, whereby damping is effected in the entire frequency range. Further damping elements are likewise possible, combinations of the possibilities already mentioned also being conceivable.

In this way it is possible to obtain a high first natural frequency of the optical element 2 despite additional elasticities in the overall system of imaging apparatus 1 and small amplitudes at natural frequencies in the working range.

At the high frequencies used for deformation, acoustic damping of the imaging apparatus 1 is additionally necessary in order that it is possible to realize a low noise level in a tenable and reasonable range. There are various possibilities, then, for obtaining acoustic damping. A first possibility is to introduce the imaging apparatus 1 into a vacuum housing. Since there is no medium for propagating the sound waves in the housing, damping can be performed in this way. Furthermore, it is also possible to achieve active acoustic damping by damping the driving itself. This can be achieved in particular by moving over for example 90% of the desired value of the required radius at a high speed and the remaining 10% at a significantly slower speed. Furthermore, it would also be conceivable to perform passive acoustic damping by enclosing the imaging apparatus 1 in its entirety, for example by mounting the imaging apparatus 1 on vibration-damping foot elements.

As a result of the adjustment of the flexure of the optical element 2 in a very large adjustment range by means of the actuator 3 of the imaging apparatus 1, the focal length of the optical element 2 changes in a very large section along its optical axis 8. This fact thus makes it possible to use the imaging apparatus 1 as a tracking optical system, for example in a holographic projection device. For tracking a wavefront of the light, an adaptive optical unit having a very high dynamic range and a high adjusting speed is in this case required depending on a viewer's position in front of a screen. An adaptive optical unit required in this way must be able to achieve a large adjustment range of the radius, have a very good shape fidelity, set convex and concave flexures and be able to, ensure a reproducible bending line. All these requirements are met by the imaging apparatus 1 according to the invention.

In this case, the tracking of the image or the image plane is effected in the direction of an optical axis of a holographic projection device in a manner dependent on a measured input parameter, such as, for example, a position of a viewer in front of a screen.

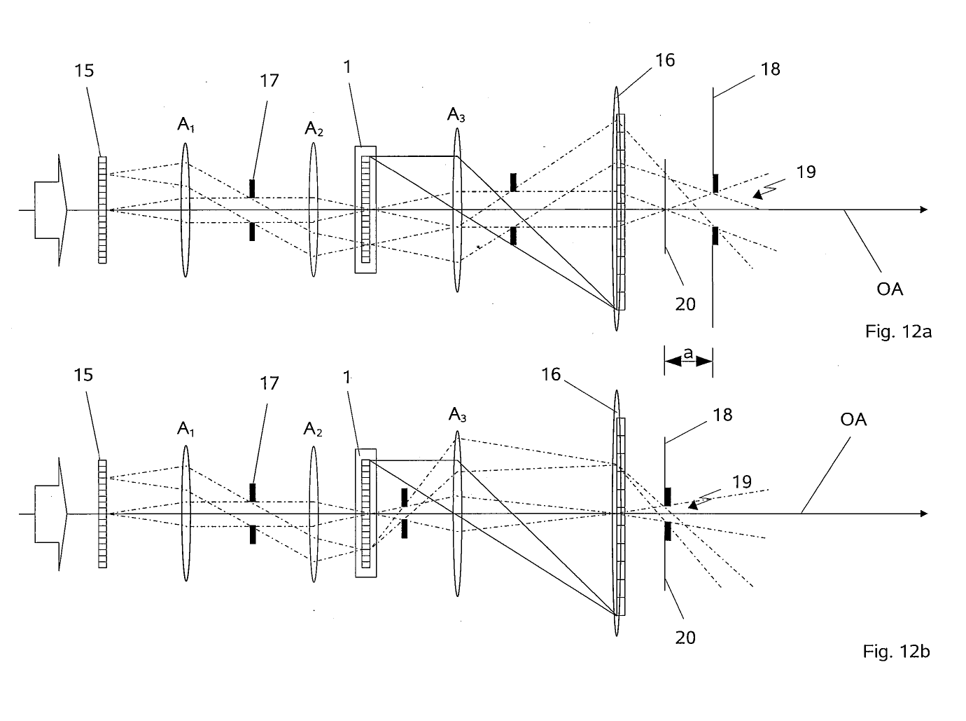

The functioning of the imaging apparatus 1 for use in a holographic projection device provided for the holographic reconstruction of two- and/or three-dimensional scenes is described below with reference to FIGS. 12a and 12b. It is also possible, of course, to employ the imaging apparatus 1 for example in astronomical telescopes, in projection exposure installations for imaging an image of a mask (reticle) onto a photosensitive substrate (wafer), in devices for material processing by means of a laser beam, in areas, such as medical technology, automotive industry or similar fields of use, in which an imaging apparatus 1 of this type is beneficial.

In the excerpts from a holographic projection device which are illustrated by FIGS. 12a and 12b, only the parts that are most important for the invention are illustrated. A holographic projection device of this type is known from DE 10 2005 023 743, for example, the functioning being described only briefly below. The holographic projection device illustrated in FIGS. 12a and 12b has a light modulation device 15, which is irradiated preferably with coherent light, imaging elements A₁, A₂, A₃ and a screen 16, a non-folded beam path being illustrated in both figures for simplification and to facilitate explanation. With regard to FIG. 12a, a hologram coded in the light modulation device 15 or the light modulation device 15 itself is imaged onto the screen 16 by means of the imaging elements A₁, A₂, A₃, which are represented here as lenses, only two beam paths being shown for illustrating the wavefront. The beam paths are illustrated by broken lines in this case. A spatial frequency filter 17 arranged in a plane of the spatial frequency spectrum, for example a diaphragm, is simultaneously imaged, by means of the imaging elements A₁, A₂, A₃ and the screen 16, into a viewer plane 18 and generates there in this way a virtual visibility region or a virtual viewer window 19. As can be discerned, the light modulation device 15 is imaged via the imaging elements A₁, A₂ into an image-side focal plane of the imaging element A₂ and into an object-side focal plane of the imaging element A₃, respectively. The image of the light modulation device 15 that arises there is an inverted image. The light modulation device 15 is thereupon imaged onto the screen 16 via the imaging element A₃. The solid beams describe how the light modulation device 15 is imaged on the screen 16. Since an inverted image of the light modulation device 15 is generated in the object-side focal plane of the imaging element A₃, an erect image of the light modulation device 15 arises again on the screen 16.

In order that a viewer can observe the reconstructed, advantageously three-dimensional scene, he must look through the virtual viewer window 19 with at least one eye, that is to say that the viewer window 19 must as far as possible coincide with a pupil of the viewer's eye. In order, however, that the reconstructed scene can still be observed without any restrictions when the viewer moves towards the screen 16 or away from it or upon movement along the optical axis OA, it is necessary to track the virtual visibility region or the virtual viewer window 19 to the viewer's respective eye.

In order to make this possible, the above-described imaging apparatus 1 for tracking the virtual viewer window 19 along the optical axis OA of the holographic projection device is arranged between at least one light modulation device 15 and the screen 16. In this case, the imaging apparatus 1 is advantageously arranged in a plane in which an image of the light modulation device 15 arises, for example between the imaging elements A₂ and A₃, this being illustrated in a highly simplified manner, however, in FIGS. 12a and 12b. The arrangement of the imaging apparatus 1 in a plane of this type is particularly important since otherwise the image of the light modulation device 15 on the screen 16 moves and a precise and required reconstruction of the scene is not possible. Since the imaging apparatus 1 is arranged on a plane of this type, it therefore has no influence on the image of the light modulation device 15 on the screen 16. FIG. 12a illustrates the two beam paths when the imaging apparatus 1 is not driven. The optical element 2 thus has an approximately planar surface.

FIG. 12b shows the holographic projection device from FIG. 12a with a curved optical element 2 of the imaging apparatus 1 in order to track the viewer window 19 along the optical axis OA. The image-side focal plane of the imaging apparatus 1 now coincides here with the object-side focal plane of the imaging element A₃. As a result, the imaging of the spatial frequency filter 17 produced in this plane is imaged into infinity, as a result of which, therefore, no imaging of the spatial frequency filter 17 is effected between the imaging element A₃ and the screen 16. In this way, the viewer window 19 produced by the imaging of the spatial frequency filter 17 is produced in an image-side focal plane 20 of the screen 16. The light modulation device 15 is simultaneously imaged onto the imaging apparatus 1 and then via the imaging element A₃ onto the screen 16, as already mentioned above. This imaging is therefore not influenced by the imaging apparatus 1. As can be seen from a comparison of the two holographic projection devices according to FIG. 12a and FIG. 12b, the viewer window 19 in FIG. 12b has been displaced by a distance a along the optical axis OA towards the screen 16.

The production of the required flexure of the optical element 2 in order to achieve a tracking of the viewer window 19, as illustrated in FIG. 12b, is described below. As already mentioned, the optical element 2 to be deformed is advantageously a cylindrical mirror. A spherical mirror as an optical element 2 would be more advantageous, but this cannot be realized with the requirements specified above. In order to produce the effect of a spherical optical element, however, two imaging apparatuses 1 which are arranged one behind another on the optical axis OA of the holographic projection device and are offset by 90° with respect to one another are provided, each imaging apparatus 1 having a cylindrical mirror. The effect of the imaging apparatus 1 with the first cylindrical mirror that is arranged first in the light direction on the optical axis OA of the holographic projection device is centred on the effect of the downstream imaging apparatus 1 with the second cylindrical mirror. In this case, the two cylindrical mirrors each act only in a mutually different plane. The two imaging apparatuses 1 arranged one after the other now have to deform their cylindrical mirrors in such a way that a change in the focus of the light is obtained as in the case of the deformation of a spherical mirror.

In order to perform a tracking of the virtual viewer window 19 along the optical axis OA of the holographic projection device, the actuators 3 of the imaging apparatuses 1 are driven in such a way that the respective optical element 2 is deformed such that a required convergence is imposed on the wavefront or is added thereto, whereby the light is focused at a corresponding position along the optical axis OA. In this way, therefore, the viewer window 19 can be tracked in the case of a change in position to the viewer or viewers along the optical axis OA towards the screen 16 or away from it.

The tracking of the virtual viewer window 19 is effected by means of the imaging apparatus 1 only in the event of movement of one or a plurality of viewers towards the screen 16 or away from it. If the viewer or viewers move(s) in the viewer plane 18, then a further imaging apparatus, for example a galvanometer mirror, is required for deflecting the wavefront in the horizontal direction.

The imaging apparatus 1 serves not only for signal tracking but also for dynamic correction of wavefront aberrations and system-dictated aberrations.

Wavefront aberrations can also simultaneously be corrected by means of the two imaging apparatuses 1 in the holographic projection device. Since the viewer also moves in the viewer plane 18, however, it is necessary here, too, to track the virtual viewer window 19 to said viewer in the event of movement in order still to enable an observation of the reconstructed scene. The tracking is effected, as mentioned above, by means of a deflection element, as a result of which, however, wavefront aberrations or aberrations occur as secondary effects. These greatly influence the quality of the tracking or of the virtual viewer window 19. In order to correct such wavefront aberrations, the surface of the optical element 2, for example only of one imaging apparatus 1, is deformed slightly differently, for example by means of a higher degree of curvature than is necessary for the tracking of the virtual viewer window 19. This means that a simultaneous correction of the wavefront aberrations and a tracking of the virtual viewer window 19 are possible, the surface of the optical element 2 being deformed in accordance with a correction of the wavefront aberrations and a particular surface shape simultaneously being added in order to produce the tracking. A geometrical addition of two surfaces is thus effected.

System-dictated aberrations or geometrical aberrations, such as astigmatism, can be corrected particularly advantageously by means of the two imaging apparatuses 1. However, other geometrical aberrations can also be corrected, the reduction of the general sum of aberrations being most expedient in the case of an optical optimization for a holographic projection device, for example.

Since lenses or lens systems (for example imaging elements A₁, A₂, A₃) are also provided besides mirrors (for example as optical element 2) in the holographic projection device for imaging the light, chromatic aberration is produced when the light passes through the lenses. That is to say that the chromatic aberration occurs in the case of imagings on account of the wavelength dependence of the refractive index of the lens. Light having different wavelengths is thus focused at different points. Since the viewer would also like to observe the reconstructed scene in colour, it is necessary to reconstruct a coloured scene in real time by means of a time division multiplex method, for example. In this case, the scene is reconstructed in colour sequentially in the three primary colours RGB (red-green-blue). Such a reconstruction requires an, advantageously coloured, light source having sufficient coherence and a switching device in order to successively switch on the individual monochromatic primary colours RGB. In this way, the coloured reconstructions can be successively generated very rapidly. The chromatic aberration that occurs in this case, however—that is to say that blue light is refracted to a greater extent than red light, the focal points of the monochromatic light beams not coinciding—therefore impairs the imaging quality.

The imaging apparatus 1, provided primarily for tracking the virtual viewer window 19, can be used to correct in particular the longitudinal chromatic aberration through corresponding deformation of the optical element 2. The position of the virtual viewer window 19 is therefore defined not only geometrically but also in a wavelength-dependent manner.

In order that a viewer can observe the coloured reconstructed scene without any restrictions, it is necessary for the switching between the individual monochromatic primary colours RGB to be effected very rapidly, the chromatic aberration simultaneously being corrected. If the reconstruction of the scene is effected in a single beam path for both of the viewer's eyes, then a changeover from the right eye to the left eye, etc. is necessary, which must in turn take place very rapidly in order to give the viewer the impression of simultaneously observing the reconstructed scene with both eyes. An additional factor is that when the viewer moves, the virtual viewer window 19 has to be tracked to the viewer to his new position. Assuming that the viewer moves at approximately 20 cm/s, the tracking of the image signal for one eye can take place slowly in the case of a deformation of the optical element 2 at approximately 25 Hz in the large range adjustment mentioned. For two eyes of a viewer, an image signal with a frequency of 50 Hz is provided, the image signal being output at 25 Hz per eye in time division multiplexing for both eyes. In this case, however, it is always necessary simultaneously to effect changeover between right eye and left eye and between the individual monochromatic primary colours RGB. This changeover is then advantageously effected at a frequency of approximately 150 Hz (fine range adjustment). In order to realize all these requirements, it is necessary for the large range adjustment to be superposed with the fine range adjustment. This can be effected by means of computer-aided control and regulating algorithms.

By means of the imaging apparatus 1, therefore, it is possible to deform an optical element for influencing impinging light in a large adjustment range at a high adjusting speed, wavefront aberrations and system-dictated aberrations additionally being able to be corrected. An imaging apparatus 1 of this type can be used especially in projection devices for tracking the light.

It goes without saying, however, that various embodiments of the imaging apparatus 1 are possible, only some preferred embodiments having been illustrated. Modifications of the embodiment shown are therefore possible without departing from the scope of the invention.

Possible fields of use of the imaging apparatus 1 besides a holographic projection device may be in the area of astronomy, in material processing by means of a laser beam or else as an element in a laser resonator.

It goes without saying that the present imaging apparatus 1 can also be used in other areas not mentioned here.

1. Imaging apparatus for influencing impinging light comprising an optical element and an actuator for deforming the optical element, the optical element having a surface facing the impinging light and the actuator having at least one piezoelectric element, the piezoelectric element being able to be driven by means of a control device, characterized in that the piezoelectric element is fitted to a rear surface and/or to that surface of the optical element which faces the impinging light, the optical element being borne by means of at least one such bearing element that has direction-dependent compliances for in each case at least one degree of freedom of rotation and/or degree of freedom of displacement, such that it is possible to achieve a substantially longitudinal-force-free bending with a substantially fixed overall position of the optical element.

2. Imaging apparatus according to claim 1, characterized in that the bearing element of the optical element comprises a spring element.

3. Imaging apparatus according to claim 1, characterized in that the piezoelectric element is an element lying areally against one surface or both surfaces of the optical element.

4. Imaging apparatus according to claim 1, characterized in that the bearing element comprises a damping element.

5. Imaging apparatus according to claim 4, characterized in that the damping element is a polymer element, an adhesive layer or a viscoelastic element.

6. Imaging apparatus according to claim 1, characterized in that at least one end section of the optical element is borne by means of the bearing element.

7. Imaging apparatus according to claim 1, characterized in that the optical element is borne on opposite sides by means of holding elements which are coupled in each case to one of the bearing elements.

8. Imaging apparatus according to claim 1, characterized in that the bearing element has a rigid intermediate member with at least two articulated joints, one of the articulated joints being connected to the end section of the optical element or one of the holding elements for the end section.

9. Imaging apparatus according to claim 1, characterized in that the bearing element has a deformable additional element, which is connected to one of the holding elements for one of the end sections of the optical element.

10. Imaging apparatus according to claim 8, characterized in that the optical element is displaceable in at least two degrees of freedom and rotatable in at least one degree of freedom.

11. Imaging apparatus according to claim 1, characterized in that the bearing element comprises an elastic polymer element that at least partly surrounds the end section of the optical element.

12. Imaging apparatus according to claim 11, characterized in that the elastic polymer element is an adhesive layer.

13. Imaging apparatus according to claim 11, characterized in that the bearing element comprises a receptacle surrounding one of the end sections of the optical element, an adhesive, elastic composition being accommodated in said receptacle.

14. Imaging apparatus according to claim 11, characterized in that the bearing element comprises a viscoelastic element.

15. Imaging apparatus according to claim 11, characterized in that the optical element is displaceable in at least one degree of freedom and rotatable in at least one degree of freedom.

16. Imaging apparatus according to claim 1, characterized in that the optical element is borne in its central region.

17. Imaging apparatus according to claim 16, characterized in that the optical element is borne by means of a bearing element embodied as a bearing element with line contact or point bearing, whereby it is possible to achieve a longitudinal-force-free bending of the optical element at least in the region laterally with respect to the bearing element.

18. Imaging apparatus according to claim 17, characterized in that the bearing element comprises a bearing element with line contact or a point bearing that has spring elements which are provided in each case laterally with respect thereto.

19. Imaging apparatus according to claim 16, characterized in that the contact between the optical element and the bearing element is small enough such that it is possible to achieve a longitudinal-force-free bending in the central region.

20. Imaging apparatus according to claim 3, characterized in that the piezoelectric element is embodied in a plurality of pieces.

21. Imaging apparatus according to claim 16, characterized in that the actuator is arranged between the bearing element and the optical element, the actuator extending over a majority of the optical element.

22. Imaging apparatus according to claim 1, characterized in that a force parallel to an optical axis of the optical element can be applied to the optical element by means of the actuator.

23. Imaging apparatus according to claim 1, characterized in that the piezoelectric element is fitted on the surface of the optical element in the optically non-active region.

24. Imaging apparatus according to claim 23, characterized in that the piezoelectric element of the actuator is embodied as a grating element applied on the surface and/or the rear surface.

25. Imaging apparatus according to claim 23, characterized in that the piezoelectric element of the actuator is at least one piezoceramic film fitted to the rear surface of the optical element, an expansion and/or a contraction of the piezoceramic film being able to be carried out by means of the control device.

26. Imaging apparatus according to claim 1, characterized in that the piezoelectric element extends at least over a majority of the width of the optical element, in particular over the entire width of the optical element.

27. Imaging apparatus according to claim 1, characterized in that the piezoelectric element has at least two piezoceramic films which can be driven in opposite senses by means of the control device.

28. Imaging apparatus according to claim 1, characterized in that the at least two piezoceramic films are arranged parallel to one another at the rear surface of the optical element.

29. Imaging apparatus according to claim 1, characterized in that the two piezoceramic films are arranged parallel to one another, one piezoceramic film being arranged at the rear surface and one piezoceramic film being arranged at the surface of the optical element, the piezoceramic film fitted to the surface having a cutout for the optically active region of the surface.

30. Imaging apparatus according to claim 1, characterized in that the piezoelectric element is prestressed.

31. Imaging apparatus according to claim 1, characterized in that the optical element is embodied as a film having an optical surface.

32. Imaging apparatus according to claim 1, characterized in that the optical surface of the optical element can be curved with a radius of curvature that can be set in an adjustment range of R=(−∞; 250 mm) to R=(+250 mm; +∞) in accordance with an influencing of the light.

33. Imaging apparatus according to claim 1, characterized in that a frequency in a range of 2 Hz to 20 Hz, preferably 5 Hz, is provided for deforming the optical element in a large adjustment range.

34. Imaging apparatus according to claim 1, characterized in that a frequency of up to 150 Hz is provided for deforming the optical element in a fine adjustment range of 5% around the desired value of the radius.

35. Imaging apparatus according to claim 1, characterized in that the thickness of the optical element (remains constant in the course of flexure.

36. Imaging apparatus according to claim 1, characterized in that the optical element is a mirror, in particular a cylindrical mirror.

37. Method for influencing light impinging on an optical element, the light impinging on the optical element being imaged, characterized in that the optical element is part of an imaging apparatus according to claim 1 and is deformed by means of an actuator through action on the optical surface and/or rear surface, such that a substantially longitudinal-force-free bending is effected with a substantially fixed overall position of the optical element.

38. Method according to claim 37, characterized in that a force for deforming the optical element is introduced into the optical element outside the optically active region of the surface.

39. Method according to claim 37, characterized in that the forces applied to the optical element by the actuator are generated mechatronically, in particular by computer-controlled application of voltage and current to the actuator.

40. Method according to claim 39, characterized in that a direction of curvature of the surface of the optical element is set by setting the polarity of the voltage applied to the actuator.

41. Method according to claim 37, characterized in that a setting of the imaging with respect to the optical element is effected by means of the deformation of the optical element.

42. Method according to claim 37, characterized in that wavefront aberrations of a wavefront imaged by means of at least one deflection element, the wavefront impinging on the deflection element at an angle, are corrected by means of the imaging apparatus provided with the optical element.

43. Method according to claim 37, characterized in that the chromatic aberration, in particular the longitudinal chromatic aberration, is corrected by means of the imaging apparatus provided with the optical element.

44. Method according to claim 37, characterized in that the shape of the optical element is corrected by varying the thickness of the actuator.

45. Method according to claim 37, characterized in that the optical element with the actuator is produced by means of the following steps:
machining a carrier material according to predefined parameters to form a film,
depositing a material serving as an optical layer on the film and fine machining,
laminating the film onto an actuator, or
coating the film with an actuator, or
applying an actuator to the film by means of a thick-film technique.

46. Method according to claim 37, characterized in that a wavefront of the light is tracked along an optical axis (OA) of a holographic projection device for representing three-dimensional scenes by means of the deformation of the optical element of the imaging apparatus, in particular in response to a monitoring of the eyes of at least one viewer.

47. System for setting the position of an image plane of an imaging in a normal direction with respect to the image plane with a regulator, by means of which an imaging apparatus according to claim 1 can be set in response to an outputting of a sensor.

48. System according to claim 47, characterized in that the sensor is a position detecting sensor.

49. System according to claim 47, characterized in that a frequency in a range of 2 Hz to 20 Hz, preferably 5 Hz, is implemented in order to place the image plane of the imaging onto the position of a viewer as detected by the position detecting sensor.

50. System according to claim 47, characterized in that an image signal for one eye of a viewer with a frequency of 25 Hz is provided, which can be finely adjusted by the imaging apparatus with the same frequency.

51. System according to claim 47, characterized in that an image signal for two eyes of a viewer with a frequency of 50 Hz is provided, in which case, for a time division multiplexing of both eyes, the image signal impinges on an optical element at 25 Hz per eye and can be finely adjusted by the imaging apparatus with the same frequency.

52. System according to claim 47, characterized in that a fine range adjustment with a frequency of 150 Hz is effected, the signal for two eyes of a viewer and for three monochromatic colours impinging on an optical element by means of a time division multiplexing.
